(19) United States
(12) Patent Application Publication
(10) Pub. No.: US 2004/0159817 A1
(43) Pub. Date: Aug. 19, 2004

(54) Flap device

(76) Inventors: Klaus Leyendecker, Hattert (DE); Guido Tillmann, Much (DE)

Correspondence Address: GROSSMAN, TUCKER, PERREALT & PFLEGER, PLLC, 55 SOUTH COMMERICAL STREET, MANCHESTER, NH, 03101, US

(21) Appl. No.: 10/780,040

(22) Filed: Feb. 17, 2004

Related U.S. Application Data
(62) Division of application No. 10/156,253, filed on May 28, 2002.

(30) Foreign Application Priority Data
May 28, 2001 (DE) 101 26 063.6

(51) Int. Cl. F16K 37/00

(52) U.S. Cl. 251/305

(57) ABSTRACT

A flap device for influencing a flow cross-section in a medium-carrying conduit includes a control element in the conduit and a shaft portion arranged rotatably with respect to the conduit. The shaft portion and the control element are connected together in torsionally stiff relationship. The shaft portion is of a cranked configuration in a region thereof between the first and second ends.

### FIELD OF THE INVENTION

The invention concerns generally a flap device and more particularly a flap device for influencing a flow cross-section in a conduit for carrying a medium therein. The invention further concerns a control element operable to influence a flow cross-section of a medium-carrying conduit. The invention additionally concerns a shaft portion for use in relation to a control element to influence a flow cross-section in a medium-carrying conduit.

### BACKGROUND OF THE INVENTION

A situation of use of a flap device for influencing a flow cross-section in a medium-carrying conduit, which can be taken by way of example in this respect, involves a flap device in an induction duct or port of an internal combustion engine. The flap device in that case can comprise a control element which is disposed in the conduit, being in the form of a flap arranged rotatably in the conduit, whereby the flow cross-section in the conduit is influenced by rotational movement of the flap. The flap device has a shaft portion having a first end and a second end, with the shaft portion being mounted rotatably with respect to the conduit and the control element being fixed in torsionally stiff relationship to the first end of the shaft portion. Such a flap can be in the form of a throttle flap, a turbulence-inducing flap, a length-control flap for controlling the effective length of the induction duct, or the like. The control element for example can moreover also be in the form of a roller.

By virtue of the cylinder arrangement and configuration of an internal combustion engine and also the cylinder head geometry, the induction system thereof may .have a plurality of induction ducts, the cross-sections of which are disposed in mutually juxtaposed relationship in one plane in the region of the transition from the induction system or manifold, to the cylinder head itself. In order to influence the flow cross-sections of the individual induction ducts in that system, the individual flap devices can be arranged in such a way that their control elements or flaps rotate about a common axis of rotation. By virtue of adopting that structural configuration, the control elements can be connected by shaft portions which thus rotate about a common axis. The control elements can be jointly actuated by means of a suitable actuating unit which is in engagement with one of the shaft portions.

For the purposes of simplifying assembly and mounting of the flap devices which are arranged in a row in the above-indicated manner, it is possible to provide for using an insert which is positioned between the induction system with its individual induction ducts, and the cylinder head. The flap devices can also be mounted directly in the induction manifold. Where an insert is employed, as indicated above, it is equipped with the individual flap devices which are thus suitably connected together by the shaft portions for joint actuation thereof. As the insert is arranged between the cylinder head and the induction system, openings or recesses have to be provided on the insert for the connecting elements, generally in screw form, which fix the induction system to the cylinder head. However, those openings or recesses have to be spaced from the axis on which the individual shaft portions of the array of flap devices are disposed so that the screws do not intersect the axis of the shaft portions. It will be appreciated however that arranging the individual screw fixing points at a spacing from the axis of rotation of the individual shaft portions results in a large amount of space being required at the region-on the cylinder head at which the induction system with the insert is mounted thereto by a flange mounting. In the case of engines which are optimised in terms of the structural space available, the use of such an insert can give rise to problems, by virtue of the space factors involved.

The influence of differing thermal expansion effects of the induction manifold and the flap device is also an aspect which tells against use of the flap device, in particular in relation to engines which are optimised in terms of the structural space involved. If the induction manifold is made from plastic material and the control element is made from metal, the different thermal expansion effects of those materials can mean that the width of the gap between the plastic induction manifold and the control element in the axial direction is not constant when differing temperatures are involved. However, a constant width of gap is desired so that the flow cross-section can be precisely influenced by the control element, irrespective of the respective temperature prevailing. In addition, it is necessary to reliably prevent the control element from expanding in such a way that it jams in the conduit whose flow cross-section it is intended to control, and as a result can no longer be actuated.

### SUMMARY OF THE INVENTION

An object of the present invention is to provide a flap device which is designed to permit use thereof more especially in internal combustion engines which are optimised in terms of structural space and which is easy to install.

Another object of the present invention is to provide a flap device for influencing a flow cross-section in a conduit, for example in an internal combustion engine, which is of a simple structure while affording a reliable cross-sectional control action.

Still another object of the present invention is to provide a flap device operable to control a flow cross-section in a conduit, which is so designed as to afford enhanced freedom of design in terms of components in its surroundings.

Yet another object of the present invention is to provide a control element for influencing a flow cross-section in a conduit, which is of a simple design configuration while being reliable in operation.

Still a further object of the invention is to provide a shaft portion suited to use with a control element in a flap device for influencing a flow cross-section in a conduit.

In accordance with the principles of the present invention the foregoing and other objects are attained by a flap device for influencing a flow cross-section in a conduit for carrying a medium therein, comprising a control element to be disposed in the conduit, and at least one shaft portion having a first end and a second end. The shaft portion can be mounted rotatably with respect to the conduit and the control element can be fixed in torsionally stiff relationship to the first end of the shaft portion. The shaft portion is cranked in a region between the first and second ends.

As will be seen from the description hereinafter of a preferred embodiment of the invention, the cranked configuration of the shaft portion between the first and second ends means that it is possible for a connecting means for securing for example an induction system to a cylinder head of an internal combustion engine, for example in the form of a screw, in the region of the cranked configuration of the shaft portion, to intersect or be in tangential relationship with the axis of rotation of the control element, more particularly between first and second control elements which are arranged in side-by-side relation-ship. That makes it possible for the individual connecting elements to be disposed between the induction ducts or ports of the induction system, on or in the proximity of the axis of rotation of the flap device. Consequently, the screw mounting points on the cylinder head can be placed closer to the axis of rotation of the flap device so that the flange region on the cylinder head can be narrower.

Even if the connecting means connecting an induction system to a cylinder head intersects the axis of rotation of a flap device in accordance with the invention, in the region of a shaft portion thereof, the cranked configuration of the shaft portion means that the functioning of the flap device is not adversely affected. As the angular range between the closed and the maximum open position of the control element in the medium-carrying conduit is at a maximum 90°. the shaft portion also rotates at a maximum through 90° about its axis of rotation. In that respect, the cranked configuration of the shaft portion is to be so designed that the cranked configuration does not touch the connecting element, when the shaft portion is rotated within the above-indicated angular range.

In accordance with a preferred feature, a control element of a further flap device for a further medium-carrying conduit can be fixed in torsionally stiff relationship to-the second end of the shaft portion. In that way, control elements which are arranged in side-by-side relationship can be mechanically coupled together in a simple manner so that they can be actuated jointly by a single actuating unit.

Preferably, the torsionally stiff connection between the control element and the shaft portion can comprise a groove-and-tongue connection.

As an alternative, the control element can also be connected to the shaft portion in torsionally stiff relationship by a press fit. In that case, the control element has a cylinder which accommodates the end of the shaft and which can be pushed on to the end of the shaft in the course of a shrink-fitting procedure.

In a preferred feature, the shaft can have a side which is flattened in the longitudinal direction of the shaft and against which the control element bears with a side which is also flat, being fixed thereto in torsionally stiff relationship. If the shaft portion and the control element consist of steel, welding for example can be appropriately adopted for fixing the two components together. In principle the two components can also be joined together by any other suitable connecting means such as adhesive or the like. The two components can also be made of plastic material and previously injection molded to the shaft portion. The control element and the shaft portion can also be made in one piece.

If a bearing arrangement is to be provided between the cranked configuration and the control element, then the bearing which accommodates the shaft must be splittable, to make it possible to fit the bearing.

In accordance with a further aspect of the invention, the foregoing and other objects are attained by a control element which, for influencing a flow cross-section of a medium-carrying conduit, can be arranged rotatably therein, wherein the control element can be secured to first and second shaft portions in torsionally stiff relationship, with the shaft portions having a common axis of rotation. The control element can comprise two sub-elements, wherein a first sub-element is connected to the first shaft portion and a second sub-element is connected to the second shaft portion. The two sub-elements engage into each other in the installed position thereof, with play in the axial direction of the shaft portions.

As will be seen in greater detail hereinafter the play between the two sub-elements of the control element means that the sub-elements can expand with an increase in temperature in the axial direction of the shaft portions without the width of the gaps between the sub-elements and the conduit being influenced thereby, in the axial direction of the shaft portions. It is possible in that way to reliably ensure that the control element does not become jammed in the conduit so it can no longer be actuated, if the control element suffers from expansion. By virtue of the play between the individual sub-elements of the control element, the gap between the control element and the wall of the conduit in the axial direction of the shaft portions can be set independently of the influence of varying temperature on expansion of the sub-elements. Therefore, the gaps between the sub-elements and the respectively adjoining walls of the conduit can be of constant or approximately constant widths, even with varying temperatures.

In a preferred feature the sub-elements at least partially overlap each other. The overlapped configuration can ensure that no unwanted flow of the medium flowing through the conduit occurs between the two sub-elements at the ends which are respectively towards each other.

In a preferred feature the sub-elements can be in torsionally stiff engagement with each other. That torsionally stiff connection between the two sub-elements means that, as in the case of a control element which is made in one piece, it is sufficient if just one portion is driven to actuate the control element.

In accordance with a preferred feature of the invention, at the end which is towards the second sub-element, the first sub-element has a displaced tooth profile into which engages a complementary tooth profile of the second sub-element. By virtue of that arrangement, the two sub-elements can be joined together by being simply pushed one on to the other, without any further connecting means being required to make a torsionally stiff connection therebetween.

The above-indicated objects in accordance with the invention can be also attained by the use of a shaft portion having a first and a second end, in a flap device for influencing a flow cross-section in a medium-carrying conduit. Control elements can be fixed to the first and/or second end of the shaft portion, with the shaft portion being cranked in a region between the first and second ends. The cranking of the shaft portion means that it is possible to arrange in the region of the cranked configuration components which intersect or touch the axis of rotation of the shaft portion. By virtue of the limited range of angular displacement the functionality of the flap device is not impaired by a component which intersects the axis of rotation of the shaft portion.

Further objects, features and advantages of the invention will be apparent from the description hereinafter of a preferred embodiment.

### BRIEF DESCRIPTION OF THE DRAWING

FIG. 1 is a perspective view showing a plurality of flap devices,

FIG. 2 is a perspective view showing an array of the flap devices in FIG. 1, which is arranged in an insert,

FIG. 3 is a perspective view of a cranked shaft portion,

FIG. 4 is a perspective view of a first sub-element, and

FIG. 5 is a perspective view of a second sub-element.

### DESCRIPTION OF THE PREFERRED EMBODIMENT

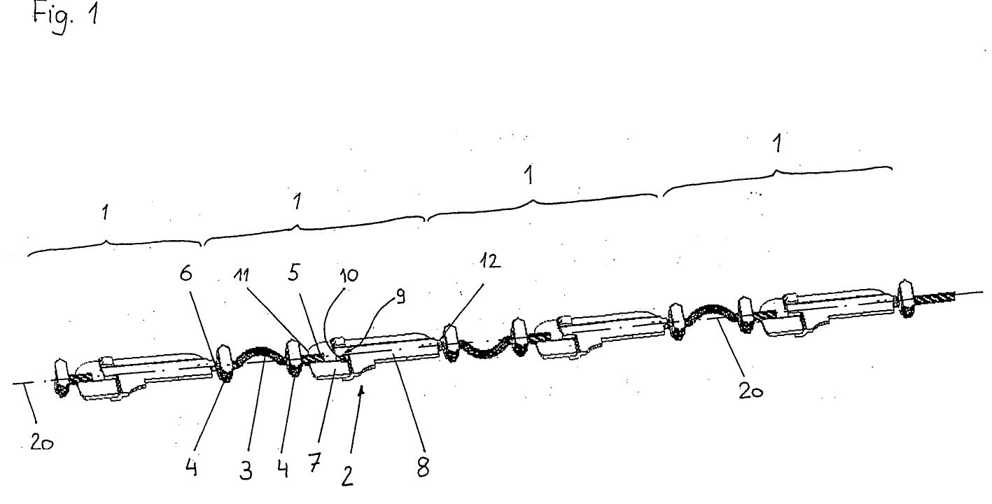

Reference will first be made to FIG. 1 showing a plurality of flap devices 1 which are arranged in a row and which are rotatable about a common axis of rotation as indicated at 20. A flap device 1 includes a control element 2 and a shaft portion 3. The respective shaft portions 3 are supported rotatably in at least one bearing bush of which one is indicated at 4. For the sake of clarity of the drawing in FIG. 1 only one of the flap devices shown therein is provided with, the appropriate reference numerals but it will be appreciated that same also apply in corresponding manner to the other flap devices shown therein.

FIG. 1 shows four flap devices 1 which are arranged in a row and of which three have a shaft portion 3 which is of a cranked configuration between the respective ends of the shaft portion 3. The control element 2 can be fixed in torsionally stiff relationship to a first end 5 of the shaft portion 3. Another control element 2 can also be fixed in torsionally stiff relationship to a second end 6 of the shaft portion. As an alternative thereto, the second end 6 of a shaft portion 3 can be arranged in a bearing bush 4 or connected to an adjusting unit which is not shown in FIG. 1.

The control element 2 includes a first sub-element or portion 7 and a second sub-element or portion 8. The sub-elements 7 and 8 are in engagement with each other at the respective end 9, 10 of the respective sub-element, that is remote from the shaft portion 3. The connection between the first sub-element 7 and the second sub-element 8 has a play in the axial direction of the respective shaft portions 3 so that the sub-elements 7, 8 can expand in the axial direction of the shaft portions 3 without that resulting in a change in the spacing in the axial direction of the shaft portions 3 between the ends 11, 12 which are towards the respective shaft portions 3.

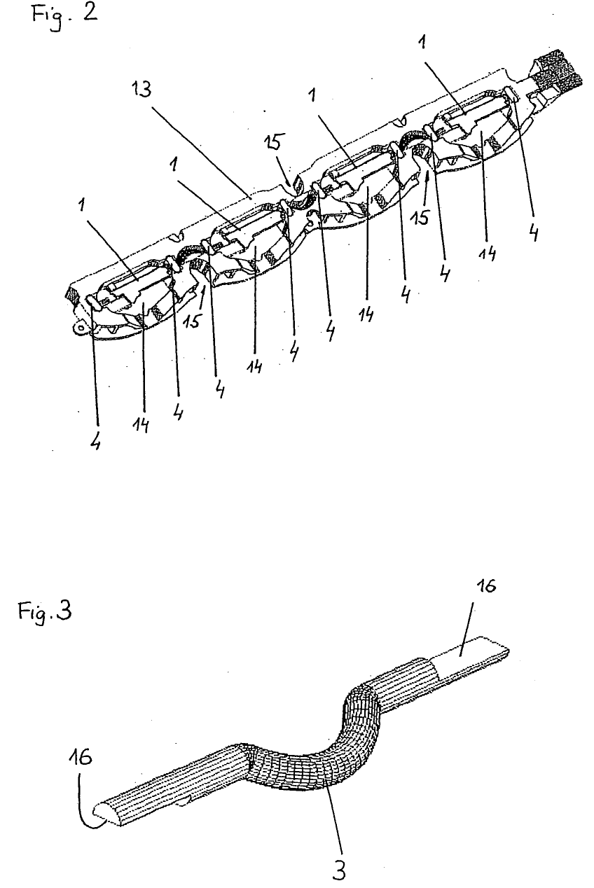

Reference will now be made to FIG. 2 showing an insert 13 which is fitted with the flap devices 1 illustrated in FIG. 1, to form a control flap insert unit. In this arrangement, the insert 13 carries the individual bearing bushes 4 so that the flap devices 1 are supported rotatably in the insert 13. The insert 13 can be fitted for example between an induction system and a cylinder head of an internal combustion engine. Reference numeral 14 denotes openings, in each of which is arranged a respective control element 2. In the installed condition of the insert the openings 14 are aligned with the corresponding induction ducts of the induction system and the ducts or ports provided in the engine cylinder head.

The insert 13 has a plurality of recesses 15 through which can engage connecting means such as for example screws which serve to secure the induction system to the cylinder head. By virtue of the cranked configuration of the shaft portions 3 which are arranged between each two control elements 2, the recesses 15 can extend beyond the axis of rotation 20 of the flap devices 1. As a result, the connecting means for fixing the induction system to the cylinder head can be brought closer to the axis of rotation 20, thereby reducing the amount of space required for the region on the cylinder head to which the induction system is mounted by a mounting flange arrangement.

Looking now at FIG. 3, shown therein is a shaft portion 3 of a flap device 1 according to the invention, which at its first and second ends indicated by references 5 and 6 for example in FIG. 1 has a side 16 which is flattened in the longitudinal direction of the shaft. The shaft portion 3 can be connected to a control element 2 in torsionally stiff relationship by applying a side, which is also flat, of a control element 2 against the flattened side 16 of the shaft portion 3 and suitably fixing the two components together in the condition of bearing against each other.

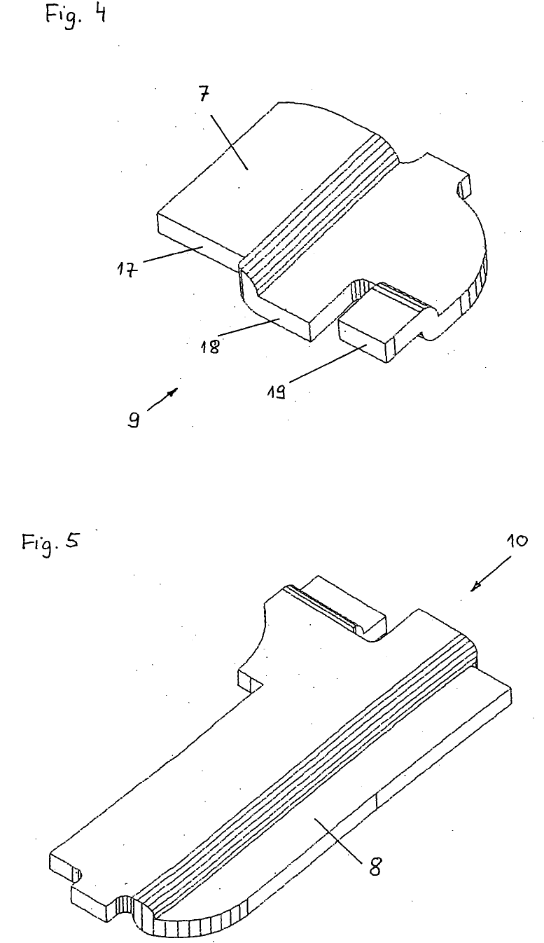

Reference will now be made to FIGS. 4 and 5 showing perspective views of the first sub-element 7 and the second sub-element 8 respectively. Looking firstly at FIG. 4, at the end 9 of the first sub-element 7, which is remote from the shaft portion 3 in the assembled condition of the components, the first sub-element 7 has a displaced tooth profile which includes three teeth indicated at 17, 18 and 19. As shown in FIG. 5, the second sub-element 8 at its end 10 remote from the shaft portion also has a tooth profile which is of a complementary configuration to the tooth profile of the first sub-element 7. In that way a first sub-element 7 and a second sub-element 8 can be connected together by being fitted one into the other with the interengaging tooth configurations forming a torsionally stiff connection between the two sub-elements 7 and 8.

It will be appreciated that the above-described embodiment of the invention has been set forth solely by way of example and illustration of the present invention and that various modifications and alterations may be made therein without thereby departing from the spirit and scope of the present invention.

What is claimed is:

1. A flap device for influencing a flow cross-section in a medium-carrying conduit, comprising
a control element arrangeable in the conduit
at least one shaft portion having a first and a second end and of a cranked configuration in a region between the first and second ends,
means mounting the shaft portion rotatably with respect to the conduit, and
means operable to fix the control element in torsionally stiff relationship to the first end of the shaft portion.

2. A flap device as set forth in claim 1 including
means adapted to fix a control element of a further flap device for a further conduit in torsionally stiff relationship to the second end of the shaft portion.

3. A flap device as set forth in claim 1
wherein the torsionally stiff connection between the control element and the shaft portion comprises a groove-and-tongue connection.

4. A flap device as set forth in claim 1
wherein the torsionally stiff connection between the control element and the shaft portion comprises a press fit.

5. A flap device as set forth in claim 1
wherein the shaft portion and the control element are formed in one piece.

6. A flap device as set forth in claim 1
wherein the shaft has a side which is flattened in the longitudinal direction of the shaft, the control element bearing against said flattened side with a flat side and being fixable thereto in torsionally stiff relationship.

7. A control element which, for influencing a flow cross-section of a medium-carrying conduit, is adapted to be arranged rotatably in said conduit,
wherein a first and a second shaft portion are adapted to be secured to the control element in torsionally stiff relationship rotatably about a common axis of rotation,
wherein the control element has first and second sub-elements,
wherein a first sub-element is connected to the first shaft portion and a second sub-element is connected to the second shaft portion, and
wherein the sub-elements engage each other with play in the axial direction of the shaft portions.

8. A control element as set forth in claim 7
wherein the sub-elements at least partially overlap each other.

9. A control element as set forth in claim 7
wherein the sub-elements are in torsionally stiff engagement with each other.

10. A control element as set forth in claim 7
wherein the first sub-element has a first end remote from the shaft portion and having a displaced tooth profile into which a complementary tooth profile of the second sub-element is engageable.

11. A shaft portion having a first and a second end, wherein at least one end can be connected in torsionally stiff relationship to a control element which, to influence a flow cross-section of a medium-carrying conduit, is adapted to be arranged in said conduit, the shaft portion being cranked in a region between the first and second ends.
